(19) United States
(12) Patent Application Publication
(10) Pub. No.: US 2005/0120761 A1
(43) Pub. Date: Jun. 9, 2005

(54) Column assembly of a vehicle having a steering column to be locked and unlocked

(76) Inventor: James E. Rouleau, Burt, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/726,741

(22) Filed: Dec. 3, 2003

(51) Int. Cl. B60R 25/02

(52) U.S. Cl. 70/185; 70/186

(57) ABSTRACT

The subject invention provides a column assembly for releasably locking and unlocking a steering column of a vehicle. The assembly includes a steering column rotatable about a central axis for imparting a direction to the vehicle and a lock bolt moveable from an unlocked position to a locked position to lock the steering column against rotation. When in the locked position, the steering column is prevented from rotating which imparts a load to the lock bolt. A lock bolt drive is connected to the lock bolt to move the lock bolt from the locked position to the unlocked position. However, the load acting on the lock bolt prevents the lock bolt drive from being able to move the lock bolt from the locked position to the unlocked position. Therefore, a release mechanism is operative to reduce the load on the lock bolt sufficiently to enable the lock bolt drive to move the lock bolt from the locked position to the unlocked position.

### BACKGROUND OF THE INVENTION

1) Field of the Invention

The subject invention relates to a column assembly of a vehicle having a steering column to be releasably locked and unlocked.

2) Description of Related Art

Various assemblies are well-known for locking a steering column. One such assembly is a lock bolt that is spring-loaded into direct or indirect releasable engagement with the steering column. Such engagement can be achieved by removable insertion of the lock bolt into a groove, a notch, teeth, or an aperture in the steering column or in a gear, plate, or other element connected to the steering column. A mechanism is normally provided for retracting the lock bolt against the spring-loaded force to unlock the steering column for vehicle operation. As is well known to those skilled in the art, the mechanism can retract the lock bolt in response to user insertion and turning of a key or in response to one or more signals from a control system coupled to an actuator driving the mechanism.

One concern with such steering column locks is the ability of the lock to reliably lock the steering column and protect against the lock bolt engaging and locking the steering column during vehicle operation. For example, the lock bolt of a steering column lock should be able to properly extend and engage with the steering column (or element connected thereto as described above) even when the steering column is being turned during non-operation. As another example, a familiar problem with many conventional steering column locks is the difficulty that a user experiences in turning the ignition key to unlock the column when a counteracting torque load is imparted to the column by back torque from the wheels. After the lock bolt has been inserted into the groove, notch, teeth, aperture and the like in its extended and locked position, the load from the front wheels can bind the lock bolt in this position and make it difficult to remove. Typically, the user must turn the steering wheel to release the force upon the lock bolt in order to turn the ignition key, retract the lock bolt, and thereby unlock the steering column.

In newer steering column locks that are not mechanically connected to an ignition lock cylinder for actuation, the lock bolt binding can be a significant problem. With the introduction in recent years of vehicle security systems in which a steering column lock is locked and unlocked by an electronic controller connected to one or more steering column lock actuators, there is little need to locate a vehicle's ignition control (e.g., switch, button, and the like) adjacent to the steering column lock. The ignition control can be directly or indirectly connected to the column lock by wiring alone, and therefore can be located almost anywhere in the vehicle. However, without the ability of a user to mechanically manipulate the lock bolt as in most older steering column lock designs described above, reliable lock bolt disengagement can be a significant problem, particularly when the lock bolt is subjected to binding forces.

One such way to overcome the load is by utilizing a more powerful lock bolt drive incorporating a larger motor. However, using the larger motor requires additional packaging space within the column assembly. Currently, the vehicle industry is striving to make the column assembly smaller and therefore, utilizing the larger motor is not desirable. Other methods of overcoming the load have incorporated additional mechanisms to push the lock bolt from the opposite side of the lock bolt drive. In this manner, the lock bolt drive is capable of overcoming a specific amount of force and the additional mechanism overcomes a specific amount of force such that when acting together, the lock bolt is moved to the unlocked position. However, adding additional mechanisms to overcome the load increases the packaging space required for the column assembly. Still other assemblies have attempted to use cams, pawls, and the like to reduce the load on the lock bolt. Others have attempted to design the lock bolt and the corresponding apertures in such a way that the load is minimized and overcome easier. In each of these assemblies, the load is not consistently and reliably released each time the column is locked and the assemblies do not assist in reducing the load. Further, when the column lock is not connected to the ignition control, these pawl, cams, and designs are less effective.

In sum, the assemblies of the prior art are characterized by one or more inadequacies. Therefore, it would be advantageous to provide a column assembly for a vehicle that reduces the load on the lock bolt consistently when the load is present to make unlocking of the steering column easier. Further, it would be advantageous to provide the assembly having fewer or smaller components, taking advantage of components that are currently existing within the column assembly, thereby reducing the packaging of the column assembly.

### BRIEF SUMMARY OF THE INVENTION

The subject invention provides a column assembly of a vehicle having a steering column to be releasably locked and unlocked. The assembly includes a steering column rotatable about a central axis and a lock bolt moveable from an unlocked position to a locked position to lock the steering column against rotation. When the lock bolt is in the locked position, a load is imparted to the lock bolt restricting movement of the lock bolt from the locked position to the unlocked position. A lock bolt drive is connected to the lock bolt for moving the lock bolt from the locked position to the unlocked position. However, in the locked position, the load prevents the lock bolt drive from being able to move the lock bolt from the locked position to the unlocked position. The assembly includes a release mechanism operative to reduce the load on the lock bolt sufficiently to enable the lock bolt drive to move the lock bolt from the locked position to the unlocked position.

The subject invention overcomes the inadequacies that characterize the related art assemblies. Specifically, the subject invention provides a column assembly that reduces the load on the lock bolt consistently, when the load is present, to make unlocking of the steering column easier. Further, the subject invention has smaller components and takes advantage of components that are currently existing within the column assembly, which further reduces the packaging of the column assembly.

### BRIEF DESCRIPTION OF THE SEVERAL VIEWS OF THE DRAWING

These and other advantages of the present invention will be readily appreciated, as the same becomes better understood by reference to the following detailed description and the accompanying drawings wherein:

FIG. 1 is a perspective view of a vehicle having a column assembly according to the subject invention;

FIG. 2 is a cross-sectional side view of the column assembly having a lock bolt and a lock bolt drive housed together with a release mechanism to reduce packaging of the column assembly;

FIG. 3 is a environmental side view of the column lock assembly having the lock bolt and the lock bolt drive housed separately from the release mechanism;

FIG. 4A is an exploded perspective view of the lock bolt and the lock bolt drive of the subject invention; and

FIG. 4B is an assembled perspective view of the lock bolt and the lock bolt drive of the subject invention.

### DETAILED DESCRIPTION OF THE INVENTION

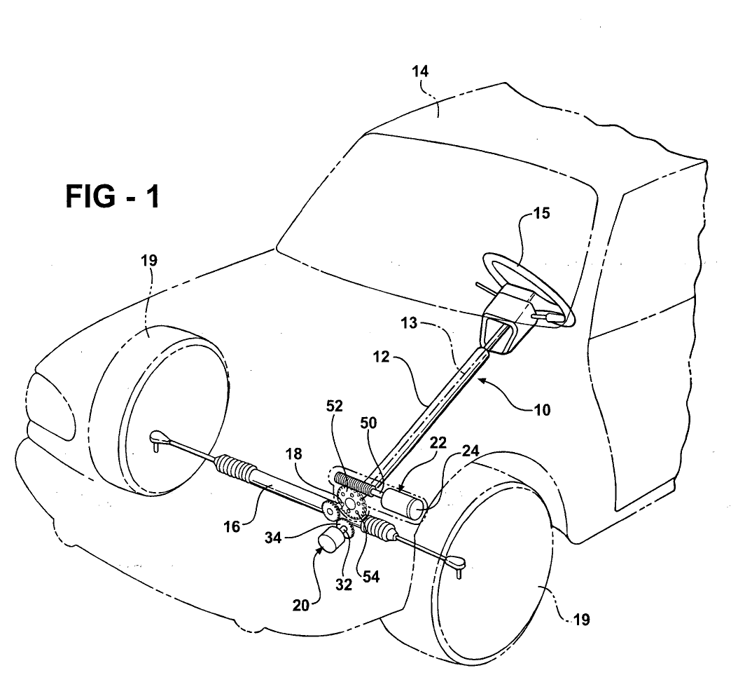

A column assembly for releasably locking and unlocking a steering column 12 of a vehicle 14 is shown generally at 10 in FIG. 1. The column assembly 10 is typically formed as part of a steering system of the vehicle 14. The steering system includes a steering column 12 rotatable about a central axis 13 for imparting a direction to the vehicle 14. A steering wheel 15 is mounted at one end of the steering column 12 and the other end of the steering column 12 engages a drive axle 16. The steering system may be any one of an electric power, a hydraulic, or a pneumatic steering system. As is becoming common within the vehicle industry, many steering systems are employing steer-by-wire systems. Most of the steer-by-wire systems include a steering assist mechanism for providing feedback to a driver while steering the vehicle 14. The vehicle industry is also attempting to reduce the packaging and the size of the column assembly 10, while also making the vehicle 14 more secure against theft. Therefore, it is advantageous to utilize existing components within the column assembly 10, such as the steering assist mechanism to minimize the size of the column assembly 10.

When the vehicle 14 is not being operated, one method for preventing theft of the vehicle 14 is to lock the steering column 12. Once locked, the column assembly 10 will be unlocked when the vehicle 14 is properly started with a key or similar device or upon receiving a signal. In order to lock the column assembly 10, a lock bolt 18 is moveable from an unlocked position to a locked. When in the locked position, the steering column 12 is prevented from rotating which imparts a load onto the lock bolt 18. The load is typically imparted from the front wheels 19 of the vehicle 14 as understood by those skilled in the art. The load is preferably a side load restricting movement of the lock bolt 18 from the locked position to the unlocked position. By side load, it is to be appreciated that since the steering column 12 wants to rotate about the central axis 13, the side load is acting against the side of the lock bolt 18. It is to be appreciated that those skilled in the art will recognize that other forces may be present to restrict movement of the lock bolt 18 other than as described.

In order to move the lock bolt 18 from the locked position to the unlocked position, a lock bolt drive 20 is connected to the lock bolt 18. However, the load acting on the lock bolt 18 prevents the lock bolt drive 20 from being able to move the lock bolt 18 from the locked position to the unlocked position. It is to be appreciated that the lock bolt drive 20 may be any type of drive, but is preferably an electric motor.

The assembly 10 includes a release mechanism 22 operative to reduce the load on the lock bolt 18. The release mechanism 22 reduces the load sufficiently to enable the lock bolt drive 20 to move the lock bolt 18 from the locked position to the unlocked position. For example, if the load acting on the lock bolt 18 is 80 Newton meters (N-m), and the lock bolt drive 20 is only able to overcome 50 N-m, then the release mechanism 22 must reduce the load by 30 N-m. One way to reduce the load is to have a release drive 24 engaging one of the steering column 12 and the lock bolt drive 20 to rotate either one of the steering column 12 and the lock bolt drive 20 circumferentially to release the load. Preferably, the release drive 24 engages the steering column 12 either directly or indirectly. Since the load is being imparted due to rotation of the steering column 12 being prevented, if the steering column 12 is rotated against the load, then the load will be reduced and will enable the lock bolt drive 20 to remove the lock bolt 18.

Preferably, the release drive 24 is coupled to the particular steering system of the vehicle 14 and utilizes components currently existing in the column assembly 10. This allows for a more compact design of the column assembly 10 since no additional components are being added. Further, since the release drive 24 is reducing the load on the lock bolt 18, the lock bolt drive 20 is able to be smaller and more compact, which further minimizes the size of the column assembly 10. The release drive 24 may be an electric motor used as the steering assist mechanism in the electric power steering system, a hydraulic motor used in the hydraulic steering systems, or a pneumatic motor used in the pneumatic steering system. It is to be understood that any one of the motors may be replaced with an equivalent device separate from the steering system, while still reducing the load on the steering column 12 sufficiently to enable removal of the lock bolt 18.

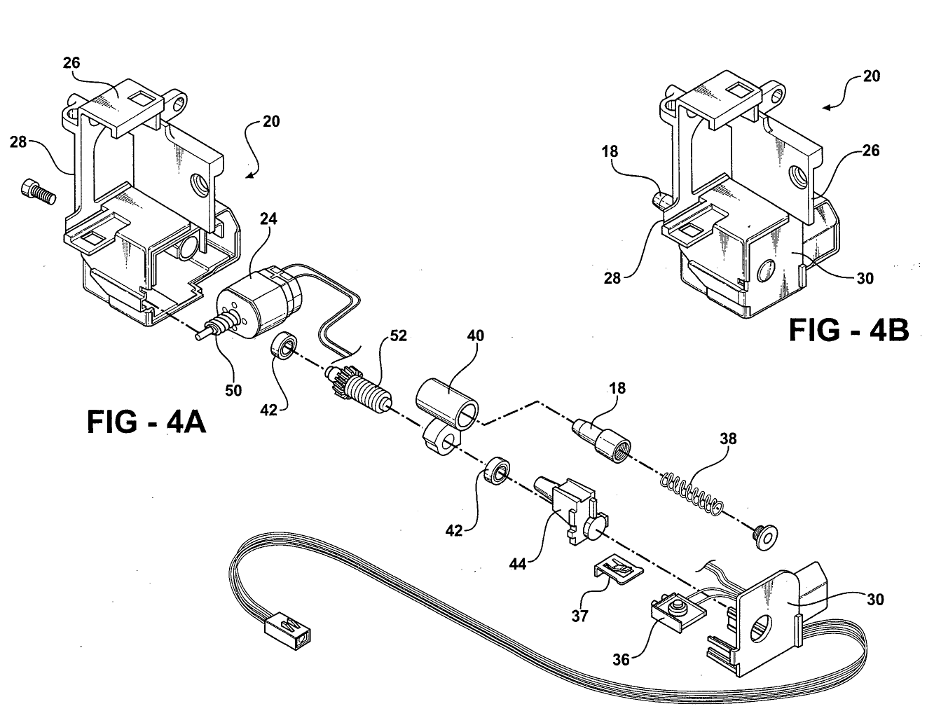

Referring to FIGS. 4A and 4B, the lock bolt 18 and the lock bolt drive 20 are shown in an exploded view and in an assembled view, respectively. The lock bolt drive 20 includes a housing 26 having a front cover 28 and a rear cover 30 such that the lock bolt 18 extends from the front cover 28. Housed within the housing 26 is a worm 32 and a worm gear 34 disposed between the motor and the lock bolt 18 for moving the lock bolt 18 from the locked to the unlocked position. The lock bolt drive 20 is also housed within the housing 26 and is preferably an electric motor, and more preferably a 5-ounce inch motor. The electric motor is turned on and off by a switch 36 which is connected to a power source (not shown). The power source preferably powers both the lock bolt drive 20 and the release mechanism 22, however, it is to be appreciated that each may have it's own power source. Most preferably, the power source is the battery used by the remainder of the vehicle 14 systems. The lock bolt drive 20 also includes a spring 38 biasing the lock bolt 18 outwardly from the front cover 28 and a carrier 40 for carrying the lock bolt 18 along the worm gear 34 and for transmitting movement between the locked and unlocked positions. Various bearings 42 also support the worm gear 34 to provide movement of the lock bolt 18 and an up-stop 44 prevents the lock bolt 18 from being moved to far. A switch actuator 37 is supported by the carrier 40 for actuating the switch 36.

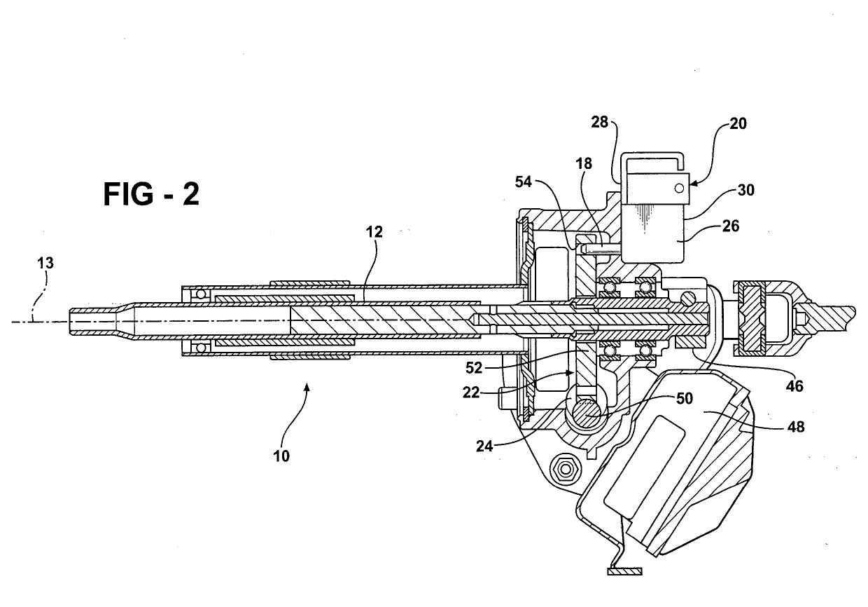

Referring to FIG. 2, the column assembly 10 may also include a sensor 46 in communication with the lock bolt drive 20 and the release mechanism 22 for sensing the load on the lock bolt 18. The sensor 46 is able to detect a direction of the load, such as clockwise or counterclockwise about the central axis 13, on the lock bolt 18. Preferably, the sensor 46 is positioned adjacent the steering column 12 to sense the load, however, it may be positioned elsewhere so long as it is capable of sensing the load. Upon detection of the load, the sensor 46 transmits a signal to a processor 48. The processor 48 is in communication with the sensor 46, the lock bolt drive 20, and the release mechanism 22 and coordinates operation of the lock bolt drive 20 and the release mechanism 22 to release the load. The processor 48 is preferably included with the vehicle's 14 electronics that are used to run the remainder of the vehicle's 14 systems as is known to those skilled in the art. If the sensor 46 detects a clockwise load on the lock bolt 18, then the processor 48 directs the release mechanism 22 to rotate in a counterclockwise direction to reduce the load and vice versa for the counterclockwise load. If the sensor 46 is not utilized, then the release mechanism 22 may rotate the steering column 12 in both the clockwise and counterclockwise direction until the load is reduced to allow removal of the lock bolt 18. Other loads may be present other than the clockwise and counterclockwise loads depending upon the specific configuration of the lock bolt 18, the lock bolt drive 20, and the release mechanism 22, so long as the loads prevent the lock bolt 18 from being moved to the unlocked position.

In one embodiment, shown in FIGS. 1 and 2, the release mechanism 22 further includes a worm 50 disposed between the release drive 24 and the steering column 12 for rotating the steering column 12 circumferentially. The worm 50 extends from the release drive 24 and engages a worm gear 52 disposed between the worm 50 and the steering column 12. The worm gear 52 defines a plurality of holes 54 spaced circumferentially about the worm gear 52 for receiving the lock bolt 18 in the locked position. Preferably, the housing 26 of the lock bolt drive 20 is housed within the column assembly 10 along with the release mechanism 22 such that packaging space and size of the column assembly 10 is reduced within the vehicle 14.

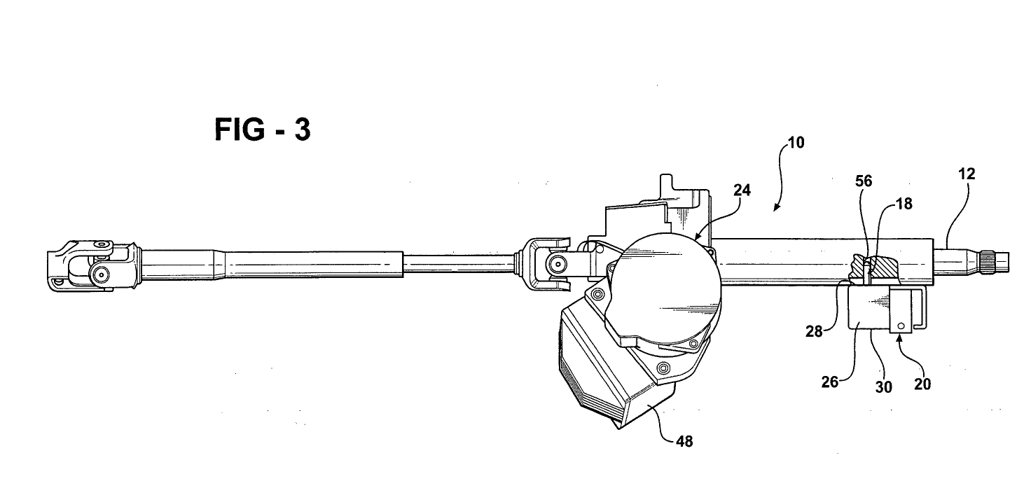

In another embodiment shown in FIG. 3, the steering column 12 defines a plurality of apertures 56 for receiving the lock bolt 18. In other words, the lock bolt 18 directly engages the steering column 12 to prevent rotation. The plurality of apertures 56 are spaced circumferentially about the steering column 12 to allow the lock bolt 18 to be adjacent the next nearest aperture 56 when moved into the locking position. In this embodiment, the release mechanism 22 is similar to that shown in FIG. 2, except that the lock bolt 18 does not engage the release mechanism 22, since it is engaging the steering column 12.

In operation, when the vehicle 14 is stopped and turned off, the lock bolt drive 20 moves the lock bolt 18 to the locked position. If the lock bolt 18 does not align with one of the holes 54 or apertures 56, the lock bolt 18 is forced into the housing 26 against the force of the spring 38. When the steering column 12 is rotated, such as by the driver turning the steering wheel 15, the lock bolt 18 is biased outwardly from the housing 26 and through the hole 54 or aperture 56. Once the lock bolt 18 engages the hole 54 or aperture 56, the steering column 12 may still want to be rotated about the central axis 13, by either a force of the wheels 19 of the vehicle 14 in contact with the ground or by the driver. This attempted rotation causes the load to be present on the lock bolt 18. The load is sufficient enough to prevent the lock bolt drive 20 from being able to move the lock bolt 18 to the unlocked position.

When the vehicle 14 is to be operated again, the steering column 12 must be unlocked. In order to unlock the steering column 12, the load on the lock bolt 18 must be reduced sufficiently to allow the lock bolt drive 20 to move the lock bolt 18. It is preferred that the moving of the lock bolt 18 and the reducing of the load happens simultaneously to provide most efficient operation of the vehicle 14. However, it is to be appreciated that a delay may be present between the reducing of the load and the moving of the lock bolt 18. In order to reduce the load, the column assembly 10 senses the load and rotates one of the steering column 12, the lock bolt 18, and the lock bolt drive 20 circumferentially about the central axis 13. Once the load is sufficiently reduced, the lock bolt 18 is moved to the unlocked position and the steering column 12 is unlocked. In the most preferred embodiment, the steering column 12 is rotated circumferentially to reduce the load. Further, if the sensor 46 is not used, then the steering column 12 may be rotated both clockwise and counterclockwise until the load is overcome and the lock bolt 18 is moved to the unlocked position.

Obviously, many modifications and variations of the present invention are possible in light of the above teachings. The invention may be practiced otherwise than as specifically described within the scope of the appended claims.

1. A column assembly of a vehicle having a steering column to be releasably locked and unlocked, said assembly comprising:
a steering column rotatable about a central axis;
a lock bolt moveable from an unlocked position to a locked position to lock said steering column against rotation whereby a load is imparted to said lock bolt when in said locked position restricting movement of said lock bolt from said locked position to said unlocked position;
a lock bolt drive connected to said lock bolt for moving said lock bolt from said locked position to said unlocked position, said load preventing said lock bolt drive from moving said lock bolt from said locked position to said unlocked position; and
a release mechanism operative to reduce said load on said lock bolt sufficiently to enable said lock bolt drive to move said lock bolt from said locked position to said unlocked position.

2. An assembly as set forth in claim 1 wherein said release mechanism further comprises a release drive engaging one of said steering column and said lock bolt drive to rotate either one of said steering column and said lock bolt drive circumferentially to release said load.

3. An assembly as set forth in claim 2 wherein said release drive is further defined as an electric motor.

4. An assembly as set forth in claim 2 wherein said release drive is further defined as a hydraulic motor.

5. An assembly as set forth in claim 2 wherein said release drive is further defined as a pneumatic motor.

6. An assembly as set forth in claim 2 wherein said release mechanism is further defined as including a worm disposed between said release drive and said steering column for rotating said steering column circumferentially.

7. An assembly as set forth in claim 6 wherein said release mechanism is further defined as including a worm gear disposed between said worm and said steering column.

8. An assembly as set forth in claim 7 wherein said worm gear further defines a plurality of holes spaced circumferentially about said worm gear for receiving said lock bolt.

9. An assembly as set forth in claim 2 wherein said lock bolt drive is further defined as including an electric motor.

10. An assembly as set forth in claim 9 wherein said lock bolt drive is further defined as including a switch for actuating said electric motor.

11. An assembly as set forth in claim 2 wherein said lock bolt drive is further defined as including a worm and a worm gear disposed between said motor and said lock bolt.

12. An assembly as set forth in claim 11 wherein said lock bolt drive is further defined as including a housing having a front cover and a rear cover such that said lock bolt extends from said front cover.

13. An assembly as set forth in claim 12 wherein said housing of said lock bolt drive is formed integrally within said release mechanism.

14. An assembly as set forth in claim 13 further including a power source for actuating both of said lock bolt drive and said release mechanism.

15. An assembly as set forth in claim 12 wherein said lock bolt drive is further defined as including a spring disposed between said lock bolt and said rear cover for biasing said lock bolt from said housing.

16. An assembly as set forth in claim 1 wherein said steering column further defines a plurality of apertures for receiving said lock bolt.

17. An assembly as set forth in claim 16 wherein said plurality of apertures are further defined as spaced circumferentially about said steering column.

18. An assembly as set forth in claim 1 further comprising a sensor in communication with said lock bolt drive and said release mechanism for sensing said load on said lock bolt.

19. An assembly as set forth in claim 18 further comprising a processor in communication with said sensor, said lock bolt drive, and said release mechanism for coordinating operation of said lock bolt drive and said release mechanism to release said load.

20. A method of locking and unlocking a steering column within a column assembly of a vehicle with a lock bolt moveable between a locked and unlocked position by a lock bolt drive, said method comprising:
locking the steering column with the lock bolt;
imparting a load on the lock bolt in response to locking the steering column with the lock bolt sufficient to prevent the lock bolt drive from being able to move the lock bolt to the unlocked position; and
reducing the load on the lock bolt to enable the lock bolt drive to move the lock bolt from the locked position to the unlocked position.

21. A method as set forth in claim 20 wherein the step of releasing the load is further defined as rotating one of the steering column, the lock bolt, and the lock bolt drive circumferentially about a central axis to sufficiently reduce the load.

22. A method as set forth in claim 21 further comprising the step of moving the lock bolt to the unlocked position in response to the load on the lock bolt being reduced.

23. A method as set forth in claim 22 further comprising the step of sensing the load on at least one of the steering column, the lock bolt, and the lock bolt drive as preventing movement of the lock bolt.

24. A method as set forth in claim 23 further comprising the step of simultaneously actuating the release mechanism and the lock bolt drive in response to sensing the load.

25. A method as set forth in claim 20 wherein the step of locking the steering column is further defined as moving the lock bolt into engagement with one of the steering column and the release mechanism.

26. A method as set forth in claim 20 wherein the step of locking the steering column is further defined as moving the lock bolt into cooperation with the steering column.

27. A method as set forth in claim 26 wherein the step of releasing the load is further defined as rotating the steering column about a central axis to release the load on the lock bolt.

28. A method as set forth in claim 27 further including the step of moving the lock bolt out of cooperation with the steering column to allow rotation about the central axis.

29. An electric power steering system for a vehicle, said system comprising:
a steering column rotatable about a central axis for steering said vehicle;
a column assembly comprising;
a lock bolt moveable from an unlocked position to a locked position to lock said steering column against rotation whereby a load is imparted to said lock bolt when in said locked position restricting movement of said lock bolt from said locked position to said unlocked position,
a lock bolt drive connected to said lock bolt for moving said lock bolt from said locked position to said unlocked position, said load preventing said lock bolt drive from moving said lock bolt from said locked position to said unlocked position, and
an electronic steering assist mechanism comprising an electric motor engaging said steering column and being operative to reduce said load on said lock bolt sufficiently to enable said lock bolt drive to move said lock bolt from said locked position to said unlocked position and for providing feedback while steering said vehicle.

30. A system as set forth in claim 29 wherein said electronic steering assist mechanism is further defined as including a worm disposed between said electric motor and said steering column for rotating said steering column circumferentially to reduce said side load and to provide feedback.

31. A system as set forth in claim 30 wherein said electronic steering assist mechanism is further defined as including a worm gear disposed between said worm and said steering column.

32. A system as set forth in claim 31 wherein said worm gear further defines a plurality of holes spaced circumferentially about said worm gear for receiving said lock bolt.
